(19) United States
(12) Patent Application Publication
(10) Pub. No.: US 2026/0310847 A1
(43) Pub. Date: Oct. 8, 2026

(54) PARETO SOLUTION SEARCH DEVICE

(71) Applicant: Mitsubishi Electric Corporation, Tokyo (JP)

(72) Inventors: Mamoru DOI, Tokyo (JP); Tadashi ONISHI, Tokyo (JP)

(73) Assignee: Mitsubishi Electric Corporation, Tokyo (JP)

(21) Appl. No.: 19/461,989

(22) Filed: Jan. 28, 2026

Related U.S. Application Data
(63) Continuation of application No. PCT/JP2023/032047, filed on Sep. 1, 2023.

(51) Int. Cl. G06F 30/20; G06F 111/06

(52) U.S. Cl. CPC G06F 30/20; G06F 2111/06

(57) ABSTRACT

A Pareto solution search device includes processing circuitry to acquire an evaluation value of each of Pareto solution candidates based on a data envelopment analysis from a simulator that calculates the evaluation value of each of M (M≥2) Pareto solution candidates based on the data envelopment analysis in a plurality of objective functions corresponding to a multi-objective problem for which a solution is obtained by a genetic algorithm using the data envelopment analysis, to calculate a relative distance between the M Pareto solution candidates, to select G (1≤G≤M) Pareto solution candidates from among the M Pareto solution candidates, on the basis of the relative distance and the evaluation values, and to create new (M-G) Pareto solution candidates different from the G Pareto solution candidates, using one or more Pareto solution candidates among the G Pareto solution candidates.

### CROSS REFERENCE TO RELATED APPLICATION

This application is a Continuation of PCT International Application No. PCT/JP2023/032047, filed on Sep. 1, 2023, which is hereby expressly incorporated by reference into the present application.

### TECHNICAL FIELD

The present disclosure relates to a Pareto solution search device.

### BACKGROUND ART

There are Pareto solution search devices that execute a genetic algorithm for obtaining a solution to a multi-objective problem, and repeatedly updates M (M being an integer of 2 or greater) Pareto solution candidates in a plurality of objective functions corresponding to the multi-objective problem. Pareto solution candidates are candidates for a solution close to an ideal solution in a multi-objective problem.

As such a Pareto solution search device, Patent Literature 1 discloses a device that implements a multi-objective optimization method including a selecting step and a changing step, for example. In the selecting step, evaluation values of M Pareto solution candidates are acquired from a simulator that calculates the evaluation values of the M Pareto solution candidates in a plurality of objective functions. In the selecting step, a process of selecting G (G being an integer that is not smaller than 1 but is smaller than M) Pareto solution candidates having relatively high evaluation values from among the M Pareto solution candidates is then performed. In the changing step, a process of newly creating (M-G) Pareto solution candidates different from the G Pareto solution candidates is performed using one or more Pareto solution candidates among the G Pareto solution candidates selected in the selecting step. In the changing step, the G Pareto solution candidates selected in the selecting step and the newly created (M-G) Pareto solution candidates are given to the simulator. The simulator calculates an evaluation value of each of the Pareto solution candidates given from the changing step. The selecting process in the selecting step and the creating process in the changing step are repeated a plurality of times.

### CITATION LIST

### Patent Literature

Patent Literature 1: JP 8-36560 A

### SUMMARY OF INVENTION

### Technical Problem

By the multi-objective optimization method implemented by the device disclosed in Patent Literature 1, the selecting process in the selecting step and the creating process in the changing step are repeated a plurality of times, and therefore, the G Pareto solution candidates finally selected by the selecting step are limited to Pareto solution candidates having relatively high evaluation values. As a result, there is a lack of diversity among the finally selected G Pareto solution candidates in some cases, which is a problem.

The present disclosure has been made to solve a problem as above, and aims to obtain a Pareto solution search device that can select more diverse Pareto solution candidates than the device disclosed in Patent Literature 1.

### Solution to Problem

A Pareto solution search device according to the present disclosure includes processing circuitry to perform acquisition of an evaluation value of each of Pareto solution candidates based on a data envelopment analysis from a simulator that calculates the evaluation value of each of M (M being an integer equal to or greater than 2) Pareto solution candidates based on the data envelopment analysis in a plurality of objective functions corresponding to a multi-objective problem for which a solution is obtained by a genetic algorithm using the data envelopment analysis, to perform calculation of a relative distance between the M Pareto solution candidates. In addition, the processing circuitry is further configured to perform selection of G (G being an integer that is equal to or greater than 1 and is smaller than M) Pareto solution candidates from among the M Pareto solution candidates, on a basis of the relative distance and the evaluation value, and to perform creation of new (M-G) Pareto solution candidates different from the G Pareto solution candidates, using one or more Pareto solution candidates among the G Pareto solution candidates, wherein the processing circuitry is configured, in the selection, to select N (N being an integer that is equal to or greater than 1 and is not greater than M) Pareto solution candidates from among the M Pareto solution candidates, on a basis of the relative distance, and to select G (G being an integer that is equal to or greater than 1 and is smaller than N) Pareto solution candidates from among the N Pareto solution candidates, on a basis of the evaluation value of each of the N Pareto solution candidates.

### Advantageous Effects of Invention

According to the present disclosure, it is possible to select more diverse Pareto solution candidates than the device disclosed in Patent Literature 1.

### BRIEF DESCRIPTION OF DRAWINGS

FIG. 1 is a configuration diagram illustrating a Pareto solution search device according to a first embodiment.

FIG. 2 is a hardware configuration diagram illustrating the hardware of the Pareto solution search device according to the first embodiment.

FIG. 3 is a hardware configuration diagram of a computer in a case where the Pareto solution search device is implemented by software, firmware, or the like.

FIG. 4 is a flowchart illustrating a Pareto solution search method that involves processing procedures to be carried out by the Pareto solution search device.

FIG. 5 is an explanatory diagram illustrating an example of a pumping system in a sewage treatment plant.

FIG. 6 is an explanatory diagram illustrating an example of M Pareto solution candidates PSₘ (m=1, . . . , M) in a multi-objective problem.

FIG. 7 is an explanatory diagram illustrating an example of an exchange process to be performed by an exchange processing unit 4a.

FIG. 8 is an explanatory diagram illustrating an example of a mutation process to be performed by a mutation processing unit 4b.

FIG. 9 is a configuration diagram illustrating a Pareto solution search device according to a second embodiment.

FIG. 10 is a hardware configuration diagram illustrating the hardware of the Pareto solution search device according to the second embodiment.

FIG. 11 is an explanatory diagram illustrating the ranks Rk to which Pareto solution candidates PSₘ (m=1, . . . , M) belong.

FIG. 12 is a configuration diagram illustrating a Pareto solution search device according to a third embodiment.

FIG. 13 is a hardware configuration diagram illustrating the hardware of the Pareto solution search device according to the third embodiment.

FIG. 14 is a configuration diagram illustrating a Pareto solution search device according to a fourth embodiment.

FIG. 15 is a hardware configuration diagram illustrating the hardware of the Pareto solution search device according to the fourth embodiment.

FIG. 16 is an explanatory diagram illustrating an example of shape correction in a case where the shape of a Pareto frontier PF is a non-convex shape.

FIG. 17 is an explanatory diagram illustrating an example of shape correction in a case where the shape of a Pareto frontier PF is a convex shape.

### DESCRIPTION OF EMBODIMENTS

To explain the present disclosure in greater detail, modes for carrying out the disclosure are described below with reference to the accompanying drawings.

### First Embodiment

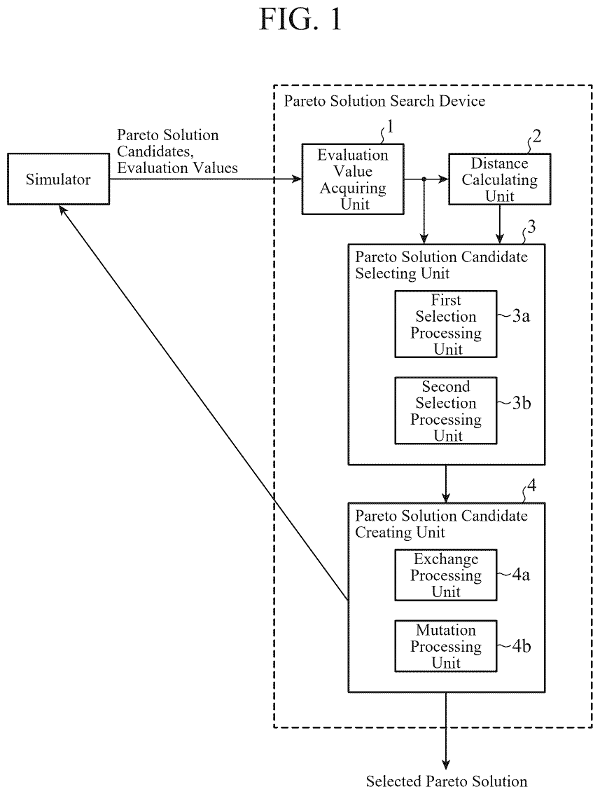

FIG. 1 is a configuration diagram illustrating a Pareto solution search device according to a first embodiment.

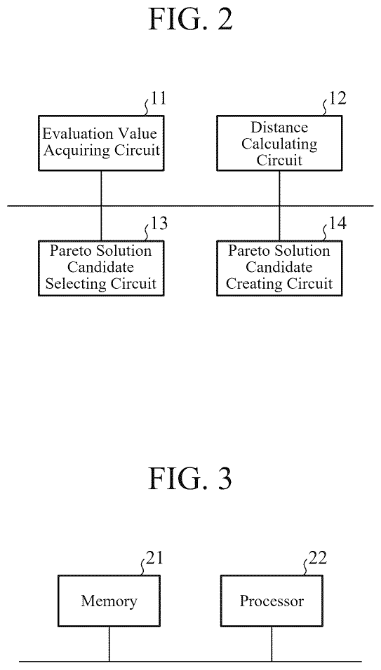

FIG. 2 is a hardware configuration diagram illustrating the hardware of the Pareto solution search device according to the first embodiment.

The Pareto solution search device illustrated in FIG. 1 is a device for executing a genetic algorithm using a data envelopment analysis (DEA), and includes an evaluation value acquiring unit 1, a distance calculating unit 2, a Pareto solution candidate selecting unit 3, and a Pareto solution candidate creating unit 4.

Several methods are known as methods included in the DEA. The Pareto solution search device illustrated in FIG. 1 is for executing a genetic algorithm using a super CCR or a genetic algorithm using a CCR among the methods included in the DEA, for example. However, the genetic algorithm to be used by the Pareto solution search device illustrated in FIG. 1 is not necessarily a super CCR or a CCR.

The evaluation value acquiring unit 1 is implemented by an evaluation value acquiring circuit 11 shown in FIG. 2, for example.

The evaluation value acquiring unit 1 acquires an evaluation value by the DEA of each Pareto solution candidate from a simulator that calculates evaluation values by the DEA of M (M being an integer of 2 or greater) Pareto solution candidates in a plurality of objective functions corresponding to a multi-objective problem for which a solution is obtained by a genetic algorithm using the DEA.

The evaluation value acquiring unit 1 outputs the respective Pareto solution candidates to each of the distance calculating unit 2 and the Pareto solution candidate selecting unit 3, and outputs the evaluation value by the DEA of each Pareto solution candidate to the Pareto solution candidate selecting unit 3.

The distance calculating unit 2 is implemented by a distance calculating circuit 12 shown in FIG. 2, for example.

The distance calculating unit 2 acquires the M Pareto solution candidates from the evaluation value acquiring unit 1.

The distance calculating unit 2 calculates a relative distance between the M Pareto solution candidates.

The distance calculating unit 2 outputs the relative distance between the M Pareto solution candidates to the Pareto solution candidate selecting unit 3.

The Pareto solution candidate selecting unit 3 is implemented by a Pareto solution candidate selecting circuit 13 shown in FIG. 2, for example.

The Pareto solution candidate selecting unit 3 includes a first selection processing unit 3a and a second selection processing unit 3b.

The Pareto solution candidate selecting unit 3 acquires each Pareto solution candidate and the evaluation value by the DEA of each Pareto solution candidate from the evaluation value acquiring unit 1, and acquires the relative distance between the M Pareto solution candidates from the distance calculating unit 2.

The Pareto solution candidate selecting unit 3 selects G (G being an integer of 1 or greater, being smaller than M,) Pareto solution candidates from among the M Pareto solution candidates, on the basis of the relative distance between the M Pareto solution candidates and the evaluation value by the DEA of each Pareto solution candidate.

The Pareto solution candidate selecting unit 3 outputs the selected G Pareto solution candidates to the Pareto solution candidate creating unit 4.

The first selection processing unit 3a selects N (N being an integer that is not smaller than 1 but is not greater than M) Pareto solution candidates from among the M Pareto solution candidates acquired by the evaluation value acquiring unit 1, on the basis of the relative distance calculated by the distance calculating unit 2.

The second selection processing unit 3b sorts out the evaluation values of the N Pareto solution candidates selected by the first selection processing unit 3a, among the evaluation values of the M Pareto solution candidates output from the evaluation value acquiring unit 1.

The second selection processing unit 3b selects G (G being an integer that is not smaller than 1 but is smaller than N) Pareto solution candidates from among the N Pareto solution candidates, on the basis of the respective evaluation values of the N Pareto solution candidates. Here, M≥N>G≥1 is satisfied.

The Pareto solution candidate creating unit 4 is implemented by a Pareto solution candidate creating circuit 14 shown in FIG. 2, for example.

The Pareto solution candidate creating unit 4 includes an exchange processing unit 4a and a mutation processing unit 4b.

The Pareto solution candidate creating unit 4 acquires the G Pareto solution candidates from the Pareto solution candidate selecting unit 3.

The Pareto solution candidate creating unit 4 newly creates (M-G) Pareto solution candidates different from the G Pareto solution candidates, using one or more Pareto solution candidates among the G Pareto solution candidates.

The Pareto solution candidate creating unit 4 outputs the G Pareto solution candidates selected by the Pareto solution candidate selecting unit 3 and the newly generated (M-G) Pareto solution candidates to the simulator.

The exchange processing unit 4a acquires any two Pareto solution candidates from among the G Pareto solution candidates.

The exchange processing unit 4a performs an exchange process of replacing some values in one Pareto solution candidate of the two Pareto solution candidates and some values in the other Pareto solution candidate with each other.

The mutation processing unit 4b acquires a Pareto solution candidate from among the G Pareto solution candidates.

The mutation processing unit 4b performs a mutation process of changing a value in the acquired Pareto solution candidate.

The simulator acquires the G Pareto solution candidates selected by the Pareto solution candidate selecting unit 3 and the (M-G) Pareto solution candidates created by the Pareto solution candidate creating unit 4, and calculates evaluation values by the DEA of the respective Pareto solution candidates.

The simulator outputs the evaluation values by the DEA of the respective Pareto solution candidates to the evaluation value acquiring unit 1.

As a result, the evaluation value acquiring process by the evaluation value acquiring unit 1, the distance calculating process by the distance calculating unit 2, the Pareto solution candidate selecting process by the Pareto solution candidate selecting unit 3, and the Pareto solution candidate creating process by the Pareto solution candidate creating unit 4 are repeated.

In FIG. 1, it is assumed that each of the evaluation value acquiring unit 1, the distance calculating unit 2, the Pareto solution candidate selecting unit 3, and the Pareto solution candidate creating unit 4, which are components of the Pareto solution search device, is implemented by dedicated hardware as illustrated in FIG. 2. That is, it is assumed that the Pareto solution search device is implemented by the evaluation value acquiring circuit 11, the distance calculating circuit 12, the Pareto solution candidate selecting circuit 13, and the Pareto solution candidate creating circuit 14.

Each of the evaluation value acquiring circuit 11, the distance calculating circuit 12, the Pareto solution candidate selecting circuit 13, and the Pareto solution candidate creating circuit 14 is a single circuit, a composite circuit, a programmed processor, a parallel-programmed processor, an application specific integrated circuit (ASIC), a field-programmable gate array (FPGA), or a combination thereof, for example.

The components of the Pareto solution search device are not necessarily implemented by dedicated hardware, and the Pareto solution search device may be implemented by software, firmware, or a combination of software and firmware.

Software or firmware is stored as a program in a memory of a computer. A computer means hardware that executes a program, and is a central processing unit (CPU), a graphics processing unit (GPU), a central processor, a processing unit, an arithmetic unit, a microprocessor, a microcomputer, a processor, or a digital signal processor (DSP), for example.

FIG. 3 is a hardware configuration diagram of a computer in a case where the Pareto solution search device is implemented by software, firmware, or the like.

In a case where the Pareto solution search device is implemented by software, firmware, or the like, a program for causing the computer to execute the respective processing procedures performed in the evaluation value acquiring unit 1, the distance calculating unit 2, the Pareto solution candidate selecting unit 3, and the Pareto solution candidate creating unit 4 is stored in a memory 21. A processor 22 of the computer then executes the program stored in the memory 21.

Further, FIG. 2 illustrates an example in which each of the components of the Pareto solution search device is implemented by dedicated hardware, and FIG. 3 illustrates an example in which the Pareto solution search device is implemented by software, firmware, or the like. However, this is merely an example, and some components in the Pareto solution search device may be implemented by dedicated hardware, while the remaining components may be implemented by software, firmware, or the like.

Next, operations to be performed by the Pareto solution search device illustrated in FIG. 1 are described.

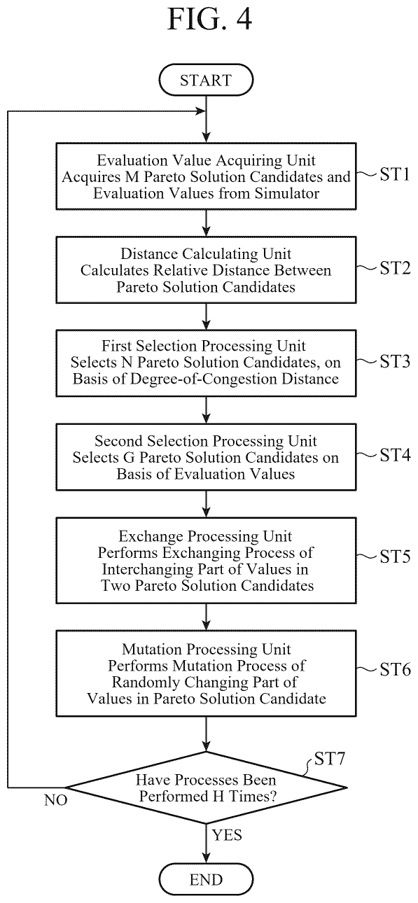

FIG. 4 is a flowchart illustrating a Pareto solution search method that involves processing procedures to be carried out by the Pareto solution search device.

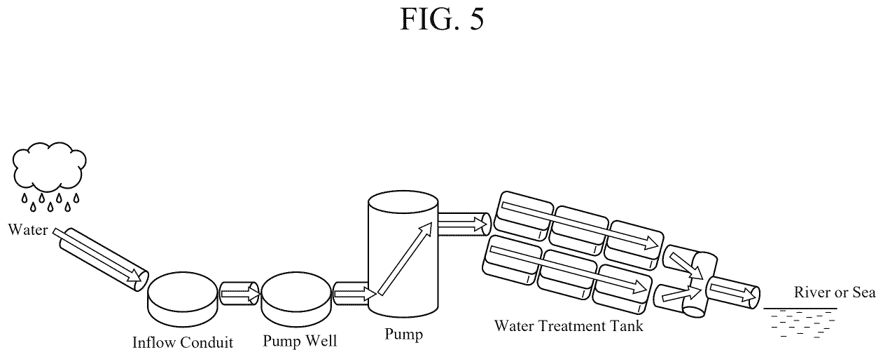

When the Pareto solution search device is used in a pumping plan or the like at a sewage treatment plant as illustrated in FIG. 5, three goals (1) to (3) as listed below are set as multiple goals, for example.

FIG. 5 is an explanatory diagram illustrating an example of a pumping system at a sewage treatment plant. Note that the three goals (1) to (3) are merely examples, and some other goals may be set.

In the pumping system illustrated in FIG. 5, rainwater or the like flows into an inflow conduit and then flows into a pump well, and a pump pumps up the water stored in the pump well into a water treatment tank. The water stored in the water treatment tank is then discharged to a river or the sea.

### Goal (1)

Avoidance of the risk of a flood is set as a goal so that the sewage treatment plant is not inundated with rainwater or the like.

### Goal (2)

A reduction of the power consumption cost is set as a goal so that the power consumption at the sewage treatment plant is reduced.

### Goal (3)

Water quality regulation for a river or the like associated with discharge of rainwater or the like from the sewage treatment plant to a river or the sea is set as a goal.

In a case where the three goals (1) to (3) are set as multiple goals, a goal function f₁ related to avoidance of the risk of a flood, a goal function f₂ related to a reduction of the power consumption cost, and a goal function f₃ related to water quality regulation for a river or the like are set as goal functions of the genetic algorithm, for example, as shown in the following Formulas (1) to (3).

The setting of the goal functions f₁, f₂, and f₃ may be performed by the evaluation value acquiring unit 1 or by the simulator, for example.

$${f}_{1} = mean ( {( max ( \frac{{y}_{1} ( t ) - {y}_{STD}}{{WLW}_{STD}} , 0 ) )}^{2} ) \qquad ( 1 )$$

$${f}_{2} = mean ( {y}_{2} ( t ) ) \qquad ( 2 )$$

$${f}_{3} = max ( max ( \frac{COD ( t )}{{COD}_{Rv}} , \frac{TN ( t )}{{TN}_{Rv}} , \frac{TP ( t )}{{TP}_{Rv}} ) , ∀ t \geq 0 , ∀ t < T ) + {Q}_{Total} \qquad ( 3 )$$

$${Q}_{Total} = max ( max ( \frac{{COD}_{Gv} ( t )}{{COD}_{TotalGv}} , \frac{{TN}_{Gv} ( t )}{{TN}_{TotalGv}} , \frac{{TP}_{Gv} ( t )}{{TP}_{TotalGv}} ) ) \qquad ( 4 )$$

In the Formulas (1) to (4), mean (x) is a mathematical symbol representing an average value of x, and max (x, y) is a mathematical symbol representing the selection of the larger one between x and y.

Further, y₁(t) represents the water level (m) of the inflow conduit at time t, y_{STD} represents the water level (m) in the standard state in the inflow conduit, and WLW_{STD} represents the water level width (m) in the standard state in the inflow conduit.

Further, y₂(t) represents the power consumption at the sewage treatment plant at time t.

COD(t) represents the chemical oxygen demand (g/L) for the river or the like at time t, TN(t) represents the total nitrogen amount (g/L) in the river or the like at time t, and TP(t) represents the total phosphorus amount (g/L) in the river or the like at time t.

COD_{Rv} represents the regulatory value (g/L) of the chemical oxygen demand, TN_{Rv} represents the regulatory value (g/L) of the total nitrogen amount, and TP_{Rv} represents the regulatory value (g/L) of the total phosphorus amount.

COD_{Gv}(t) represents the total value of the chemical oxygen demand for the river or the like at time t, TN_{Gv}(t) represents the total value of the total nitrogen amount in the river or the like at time t, and TP_{Gv}(t) represents the total value of the total phosphorus amount in the river or the like at time t.

COD_{TotalGv}(t) represents the regulatory value (Kg) of the total value of the chemical oxygen demand, TN_{TotalGv} represents the regulatory value (Kg) of the total value of the total nitrogen amount, and TP_{TotalGv} represents the regulatory value (Kg) of the total value of the total phosphorus amount.

The simulator calculates evaluation values by the DEA Evₘ (m=1, . . . , M) in M (M being an integer of 2 or greater) Pareto solution candidates PS₁ to PS_{M} in a plurality of objective functions.

When the plurality of objective functions are f₁, f₂, and f₃, the respective evaluation values Evₘ in the M Pareto solution candidates PS₁ to PS_{M} in the objective functions f₁, f₂, and f₃ are calculated.

The process to be performed by the simulator to calculate an evaluation value Evₘ of a Pareto solution candidate PSₘ (m=1, . . . , M) is a known technique, and therefore, detailed explanation thereof is not made herein. Incidentally, if the plurality of objective functions are two objective functions f₁ and f₂, an evaluation value Evₘ of a Pareto solution candidate PSₘ is obtained according to the following evaluation formula. Note that the following evaluation formula is merely an example, and the evaluation value Evₘ of a Pareto solution candidate PSₘ may be obtained according to some other evaluation formula.

### [Evaluation Formula]

$${Ev}_{m} = ( Wa \times {f}_{1} ) + ( Wb \times {f}_{2} )$$

Wa represents the weight coefficient for the objective function f₁, and Wb represents the weight coefficient for the objective function f₂.

When the evaluation value Evₘ of a Pareto solution candidate PSₘ that puts more weight on the objective function f₁ than on the objective function f₂ is calculated, the weight coefficient Wa is set to a greater value than the weight coefficient Wb. When the evaluation value Evₘ of a Pareto solution candidate PSₘ that puts more weight on the objective function f₂ than on the objective function f₁ is calculated, on the other hand, the weight coefficient Wa is set to a smaller value than the weight coefficient Wb.

The evaluation value acquiring unit 1 acquires the Pareto solution candidates PSₘ (m=1, . . . , M) and the evaluation values Evₘ of the Pareto solution candidates PSₘ from the simulator (step ST1 in FIG. 4). However, in a case where the evaluation value acquiring unit 1 sets the Pareto solution candidates PSₘ, the evaluation value acquiring unit 1 transmits the Pareto solution candidates PSₘ to the simulator. In this case, the evaluation value acquiring unit 1 acquires only the evaluation values Evₘ of the Pareto solution candidates PSₘ from the simulator, without acquiring the Pareto solution candidates PSₘ.

FIG. 6 is an explanatory diagram illustrating an example of the M Pareto solution candidates PSₘ (m=1, . . . , M) in a multi-objective problem.

FIG. 6 illustrates an example in which there are two objective functions f₁ and f₂, and M=10, for simplification of explanation.

In FIG. 6, black circles indicate the Pareto solution candidates PSₘ.

The horizontal axis in FIG. 6 indicates the value f₁(x, y) of the objective function f₁ that changes depending on design variables x and y when the design variables of the objective function f₁ are x and y, for example. For example, −1≤x≤1, and −1≤y≤1.

The vertical axis in FIG. 6 indicates the value f₂(x, y) of the objective function f₂ that changes depending on design variables x and y when the design variables of the objective function f₂ are x and y, for example.

The evaluation value acquiring unit 1 outputs the Pareto solution candidates PSₘ to each of the distance calculating unit 2 and the Pareto solution candidate selecting unit 3, and outputs the evaluation values Evₘ of the Pareto solution candidates PSₘ to the Pareto solution candidate selecting unit 3.

The distance calculating unit 2 acquires the Pareto solution candidates PSₘ (m=1, . . . , M) from the evaluation value acquiring unit 1.

The distance calculating unit 2 calculates a relative distance Lₘ (m=1, . . . , M) between the M Pareto solution candidates PS₁ to PS_{M} (step ST2 in FIG. 4).

The distance calculating unit 2 outputs the relative distance Lₘ to the Pareto solution candidate selecting unit 3.

In the following, a process to be performed by the distance calculating unit 2 to calculate the relative distance Lₘ is specifically described.

With attention being paid to the Pareto solution candidate PS₁ among the M Pareto solution candidates PS₁ to PS_{M}, the distance calculating unit 2 calculates the distance L_{1,m} between the Pareto solution candidate PS₁ and a Pareto solution candidate PSₘ (m=2, . . . , M). As the distance L_{1,m} between the Pareto solution candidate PS₁ and the Pareto solution candidate PSₘ, the Euclidean distance between the Pareto solution candidate PS₁ and the Pareto solution candidate PSₘ is calculated, for example.

With attention being paid to the Pareto solution candidate PS₂ among the M Pareto solution candidates PS₁ to PS_{M}, the distance calculating unit 2 calculates the distance L_{2,m} between the Pareto solution candidate PS₂ and a Pareto solution candidate PSₘ (m=1, 3, . . . , M). As the distance L_{2,m} between the Pareto solution candidate PS₂ and the Pareto solution candidate PSₘ, the Euclidean distance between the Pareto solution candidate PS₂ and the Pareto solution candidate PSₘ is calculated, for example.

With attention being paid to the Pareto solution candidate PS_{M} among the M Pareto solution candidates PS₁ to PS_{M}, the distance calculating unit 2 calculates the distance L_{M,m} between the Pareto solution candidate PS_{M} and a Pareto solution candidate PSₘ (m=1, . . . , M−1). As the distance L_{M,m} between the Pareto solution candidate PS_{M} and the Pareto solution candidate PSₘ, the Euclidean distance between the Pareto solution candidate PS_{M} and the Pareto solution candidate PSₘ is calculated, for example.

The first selection processing unit 3a of the Pareto solution candidate selecting unit 3 acquires the Pareto solution candidates PSₘ (m=1, . . . , M) from the evaluation value acquiring unit 1, and acquires the relative distances Lₘ (m=1, . . . , M) between the M Pareto solution candidates PS₁ to PS_{M} from the distance calculating unit 2.

The first selection processing unit 3a calculates the sum of (M−1) distances Lₘ as a degree-of-congestion distance ΣLₘ for each Pareto solution candidate PSₘ (m=1, . . . , M).

Specifically, with attention being paid to the Pareto solution candidate PS₁ among the M Pareto solution candidates PS₁ to PS_{M}, for example, the first selection processing unit 3a calculates the sum of the (M−1) distances L_{1,m} as the degree-of-congestion distance ΣL₁ as shown in the following Formula (5).

$$\sum {L}_{1} = {L}_{1 , 2} + {L}_{1 , 3} + … + {L}_{1 , M} \qquad ( 5 )$$

With attention being paid to the Pareto solution candidate PS₂ among the M Pareto solution candidates PS₁ to PS_{M}, for example, the first selection processing unit 3a calculates the sum of the (M−1) distances L_{2,m} as the degree-of-congestion distance ΣL₂ as shown in the following Formula (6).

$$\sum {L}_{2} = {L}_{2 , 1} + {L}_{2 , 3} + … + {L}_{2 , M} \qquad ( 6 )$$

With attention being paid to the Pareto solution candidate PS_{M} among the M Pareto solution candidates PS₁ to PS_{M}, for example, the first selection processing unit 3a calculates the sum of the (M−1) distances L_{M,m} as the degree-of-congestion distance ΣL_{M} as shown in the following Formula (7).

$$\sum {L}_{M} = {L}_{M , 1} + {L}_{M , 2} + … + {L}_{M , M - 1} \qquad ( 7 )$$

The first selection processing unit 3a compares the M degree-of-congestion distances ΣL₁ to ΣL_{M} with one another.

On the basis of the result of the comparison among the degree-of-congestion distances ΣL₁ to ΣL_{M}, the first selection processing unit 3a preferentially selects N (N being an integer that is not smaller than 1 but is not greater than M) Pareto solution candidates each having a relatively long degree-of-congestion distance ΣL from among the M Pareto solution candidates PS₁ to PS_{M} (step ST3 in FIG. 4).

The first selection processing unit 3a outputs the selected N Pareto solution candidates PS′₁ to PS′_{N} to the second selection processing unit 3b.

As the first selection processing unit 3a selects the N Pareto solution candidates PS′₁ to PS′_{N} on the basis of the degree-of-congestion distance ΣL, the diverseness among the Pareto solution candidates is enhanced.

The second selection processing unit 3b acquires the evaluation values Evₘ of the Pareto solution candidates PSₘ (m=1, . . . , M) from the evaluation value acquiring unit 1, and acquires the N Pareto solution candidates PS′₁ to PS′_{N} from the first selection processing unit 3a.

The second selection processing unit 3b selects evaluation values Ev′₁ to Ev′_{N} corresponding to the N Pareto solution candidates PS′₁ to PS′_{N} from among M evaluation values Ev₁ to Ev_{M}.

The second selection processing unit 3b selects G Pareto solution candidates PS″₁ to PS″_{G} from among the N Pareto solution candidates PS′₁ to PS′_{N}, on the basis of the respective evaluation values Ev′ₙ (n=1, . . . , N) of the N Pareto solution candidates PS′₁ to PS′_{N} (step ST4 in FIG. 4).

Specifically, the second selection processing unit 3b selects the top G Pareto solution candidates PS″₁ to PS″_{G} each having a relatively high evaluation value Ev′ₙ from among the N Pareto solution candidates PS′₁ to PS′_{N}.

The second selection processing unit 3b outputs the selected G Pareto solution candidates PS″₁ to PS″_{G} to the Pareto solution candidate creating unit 4.

The Pareto solution candidate creating unit 4 acquires the G Pareto solution candidates PS″₁ to PS″_{G} from the Pareto solution candidate selecting unit 3.

The Pareto solution candidate creating unit 4 newly creates (M-G) Pareto solution candidates different from the G Pareto solution candidates, using one or more Pareto solution candidates among the G Pareto solution candidates PS″₁ to PS″_{G}.

The Pareto solution candidate creating unit 4 outputs the G Pareto solution candidates and the (M-G) Pareto solution candidates to the simulator.

In the following, a process to be performed by the Pareto solution candidate creating unit 4 to create the (M-G) Pareto solution candidates is specifically described.

The exchange processing unit 4a acquires any two Pareto solution candidates from among the G Pareto solution candidates PS″₁ to PS″_{G}.

Here, for ease of explanation, it is assumed that the two Pareto solution candidates are PS″₁, and PS″₂.

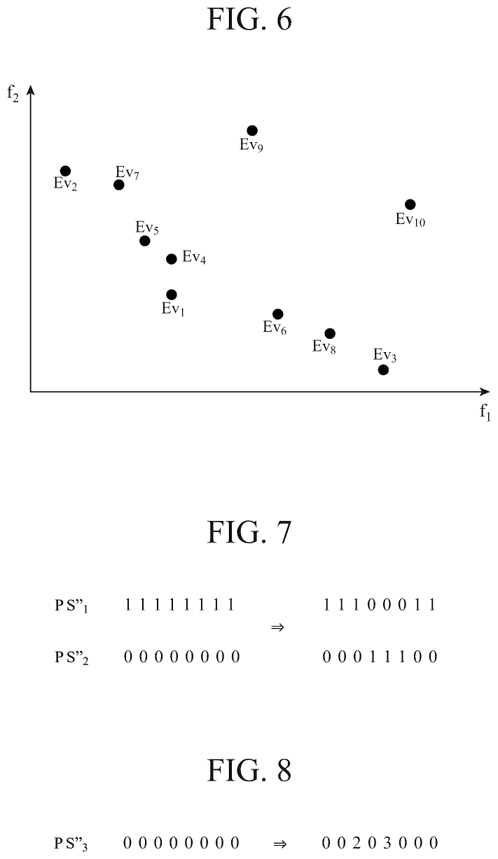

As illustrated in FIG. 7, the exchange processing unit 4a performs an exchange process of replacing some values in the Pareto solution candidate PS″₁ and some values in the Pareto solution candidate PS″₂ with each other, depending on a crossing probability (step ST5 in FIG. 4). The exchange process is a known technique, and therefore, detailed explanation thereof is not made herein.

FIG. 7 is an explanatory diagram illustrating an example of the exchange process to be performed by the exchange processing unit 4a.

As the exchange processing unit 4a performs the exchange process, the diverseness among the Pareto solution candidates is enhanced.

In the example in FIG. 7, “111” from the fourth bit to the sixth bit in the Pareto solution candidate PS″₁ and “000” from the fourth bit to the sixth bit in the Pareto solution candidate PS″₂ are replaced with each other.

Here, the exchange processing unit 4a performs an exchange process of replacing some values in the Pareto solution candidate PS″₁ and some values in the Pareto solution candidate PS″₂ with each other. Note that this is merely an example, and the exchange processing unit 4a may perform an exchange process of replacing some values in the Pareto solution candidate PS″₃ and some values in the Pareto solution candidate PS″₄ with each other, for example, in addition to the exchange process of replacing some values in the Pareto solution candidate PS″₁ and some values in the Pareto solution candidate PS″₂ with each other.

Hereinafter, the Pareto solution candidates after the exchange process performed by the exchange processing unit 4a will be referred to as PS_{Cr}.

The mutation processing unit 4b acquires a Pareto solution candidate from among the G Pareto solution candidates PS″₁ to PS″_{G}.

Here, for ease of explanation, it is assumed that the Pareto solution candidate is PS″₃.

As illustrated in FIG. 8, the mutation processing unit 4b performs a mutation process of changing some values in the Pareto solution candidate PS″₃, depending on a mutation probability (step ST6 in FIG. 4). The mutation process is a known technique, and therefore, detailed explanation thereof is not made herein.

FIG. 8 is an explanatory diagram illustrating an example of the mutation process to be performed by the mutation processing unit 4b.

As the mutation processing unit 4b performs the mutation process, the diverseness among the Pareto solution candidates is enhanced.

In the example in FIG. 8, “0” at the third bit in the Pareto solution candidate PS″₃ is changed to “2”, and “0” at the fifth bit in the Pareto solution candidate PS″₃ is changed to “3”.

Hereinafter, the Pareto solution candidate after the mutation process performed by the mutation processing unit 4b will be referred to as PS_{Mu}.

If the number of times the series of processes by the evaluation value acquiring unit 1, the distance calculating unit 2, the Pareto solution candidate selecting unit 3, and the Pareto solution candidate creating unit 4 have been performed has not reached H (step ST7 in FIG. 4: NO), the Pareto solution candidate creating unit 4 gives the simulator the G Pareto solution candidates PS″₁ to PS″_{G} selected by the Pareto solution candidate selecting unit 3, the Pareto solution candidates PS_{Cr} after the exchange processing, and the Pareto solution candidates PS_{Mu} after the mutation process. His an integer of 1 or greater.

The simulator calculates, as the respective evaluation values Evₘ (m=1, . . . , M) of the M Pareto solution candidates PS₁ to PS_{M} in the plurality of objective functions, the respective evaluation values of the G Pareto solution candidates PS″₁ to PS″_{G}, the evaluation values of the Pareto solution candidates PS_{Cr} after the exchange process, and the evaluation value of the Pareto solution candidate PS_{Mu} after the mutation process.

The simulator outputs the M Pareto solution candidates PS₁ to PS_{M} and the respective evaluation values Evₘ (m=1, . . . , M) of the M Pareto solution candidates PS₁ to PS_{M} to the evaluation value acquiring unit 1.

Each of the evaluation value acquiring unit 1, the distance calculating unit 2, the Pareto solution candidate selecting unit 3, and the Pareto solution candidate creating unit 4 performs the processes in steps ST1 to ST6 in FIG. 4.

If the number of times the series of processes by the evaluation value acquiring unit 1, the distance calculating unit 2, the Pareto solution candidate selecting unit 3, and the Pareto solution candidate creating unit 4 have been performed has reached H (step ST7 in FIG. 4: YES), the Pareto solution candidate creating unit 4 causes a display device (not shown), for example, to display the G Pareto solution candidates PS″₁ to PS″_{G} selected by the Pareto solution candidate selecting unit 3, as the result of the final selection of Pareto solutions.

In the first embodiment, the Pareto solution search device is configured to include: the evaluation value acquiring unit 1 that acquires an evaluation value based on a data envelopment analysis of each Pareto solution candidate from a simulator that calculates evaluation values based on the data envelopment analysis of M (M being an integer of 2 or greater) Pareto solution candidates in a plurality of objective functions corresponding to a multi-objective problem for which a solution is obtained by a genetic algorithm using the data envelopment analysis; and the distance calculating unit 2 that calculates a relative distance between the M Pareto solution candidates. The Pareto solution search device also includes: the Pareto solution candidate selecting unit 3 that selects G (G being an integer that is not smaller than 1 but is smaller than M) Pareto solution candidates from among the M Pareto solution candidates, on the basis of the relative distance calculated by the distance calculating unit 2 and the evaluation values acquired by the evaluation value acquiring unit 1; and the Pareto solution candidate creating unit 4 that newly creates (M-G) Pareto solution candidates different from the G Pareto solution candidates, using one or more Pareto solution candidates among the G Pareto solution candidates selected by the Pareto solution candidate selecting unit 3. Thus, the Pareto solution search device can select more diverse Pareto solution candidates than the device disclosed in Patent Literature 1 can.

In the Pareto solution search device illustrated in FIG. 1, the first selection processing unit 3a calculates the sum of the (M−1) distances Lₘ as the degree-of-congestion distance ΣLₘ (m=1, . . . , M). Note that this is merely an example, and the first selection processing unit 3a may calculate an average value of the (M−1) distances Lₘ as the degree-of-congestion distance ΣLₘ (m=1, . . . , M), for example. In this case, the first selection processing unit 3a also preferentially selects N Pareto solution candidates each having a relatively long degree-of-congestion distance ΣL from among the M Pareto solution candidates PS₁ to PS_{M}, on the basis of the result of comparison among the degree-of-congestion distances ΣL₁ to ΣL_{M}.

In the Pareto solution search device illustrated in FIG. 1, the second selection processing unit 3b selects the G Pareto solution candidates PS″₁ to PS″_{G} each having a relatively high evaluation value Ev′ₙ from among the N Pareto solution candidates PS′₁ to PS′_{N}. Note that this is merely an example, and the second selection processing unit 3b may select the G Pareto solution candidates PS″₁ TO PS″_{G} by a binary tournament technique, for example.

By the binary tournament technique, two Pareto solution candidates PS' are randomly selected from among the N Pareto solution candidates PS′₁ to PS′_{N}, and the Pareto solution candidate having the higher evaluation value Ev′ₙ between the two Pareto solution candidates PS' is selected. By the binary tournament technique, this process is repeatedly performed until the G Pareto solution candidates PS″₁ to PS″_{G} are selected.

### Second Embodiment

A second embodiment concerns a Pareto solution search device including a rank identifying unit 5 that determines superiority of M Pareto solution candidates PS₁ to PS_{M} on the basis of evaluation values Evₘ (m=1, . . . , M) acquired by an evaluation value acquiring unit 1, and identifies ranks Rk to which the respective Pareto solution candidates PSₘ belong among a plurality of ranks Rk, on the basis of the result of the determination of the superiority.

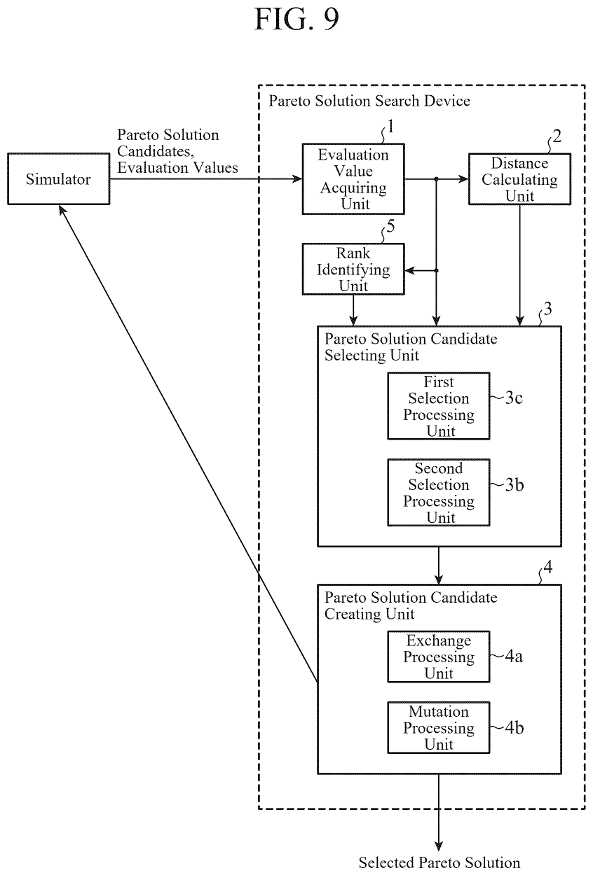

FIG. 9 is a configuration diagram illustrating the Pareto solution search device according to the second embodiment. In FIG. 9, the same reference numerals as those in FIG. 1 denote the same or corresponding components, and therefore, detailed explanation of them is not made herein.

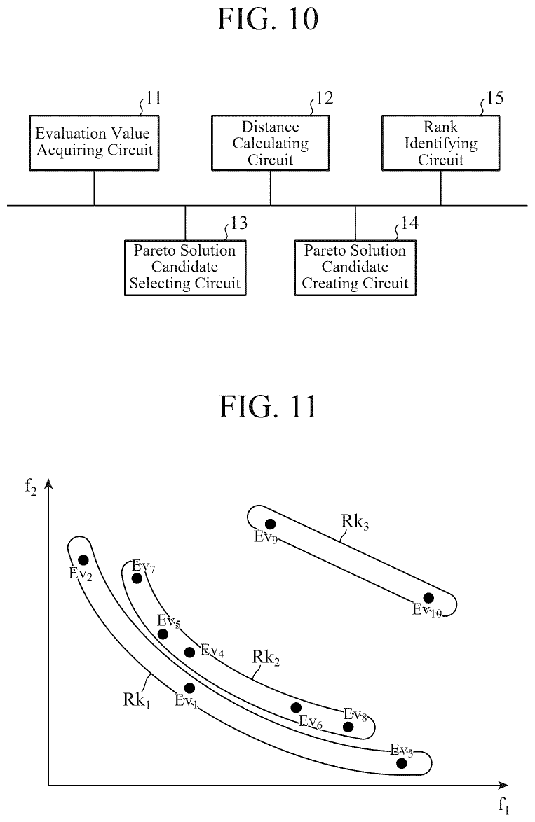

FIG. 10 is a hardware configuration diagram illustrating the hardware of the Pareto solution search device according to the second embodiment. In FIG. 10, the same reference numerals as those in FIG. 2 denote the same or corresponding components, and therefore, detailed explanation of them is not made herein.

The Pareto solution search device illustrated in FIG. 9 is a device for executing a genetic algorithm using DEA, and includes the evaluation value acquiring unit 1, a distance calculating unit 2, the rank identifying unit 5, a Pareto solution candidate selecting unit 3, and a Pareto solution candidate creating unit 4.

The rank identifying unit 5 is implemented by a rank identifying circuit 15 shown in FIG. 10, for example.

The rank identifying unit 5 acquires Pareto solution candidates PSₘ (m=1, . . . , M) and evaluation values Evₘ of the Pareto solution candidates PSₘ from the evaluation value acquiring unit 1.

The rank identifying unit 5 determines superiority of the M Pareto solution candidates PS₁ to PS_{M}, on the basis of the evaluation values Evₘ.

The rank identifying unit 5 identifies the ranks Rk to which the Pareto solution candidates PSₘ (m=1, . . . , M) belong among the plurality of ranks Rk, on the basis of the result of the determination of the superiority.

The rank identifying unit 5 outputs the ranks Rk to which the Pareto solution candidates PSₘ (m=1, . . . , M) belong, to the Pareto solution candidate selecting unit 3.

The Pareto solution candidate selecting unit 3 is implemented by a Pareto solution candidate selecting circuit 13 shown in FIG. 10, for example.

The Pareto solution candidate selecting unit 3 includes a first selection processing unit 3c and a second selection processing unit 3b.

Like the first selection processing unit 3a shown in FIG. 1, the first selection processing unit 3c acquires the Pareto solution candidates PSₘ (m=1, . . . , M) from the evaluation value acquiring unit 1, and acquires relative distances Lₘ (m=1, . . . , M) between the M Pareto solution candidates PS₁ to PS_{M} from the distance calculating unit 2.

Like the first selection processing unit 3a shown in FIG. 1, the first selection processing unit 3c acquires N Pareto solution candidates PS′₁ to PS′_{N} from among the M Pareto solution candidates PS₁ to PS_{M} acquired by the evaluation value acquiring unit 1, on the basis of the relative distances Lₘ (m=1, . . . , M).

However, unlike the first selection processing unit 3a shown in FIG. 1, the first selection processing unit 3c selects Pareto solution candidates PS' from among the Pareto solution candidates PS belonging to the respective ranks Rk, on the basis of the relative distances Lₘ (m=1, . . . , M), so that the number of selected Pareto solution candidates PS' is N in total.

In FIG. 9, it is assumed that each of the evaluation value acquiring unit 1, the distance calculating unit 2, the rank identifying unit 5, the Pareto solution candidate selecting unit 3, and the Pareto solution candidate creating unit 4, which are components of the Pareto solution search device, is implemented by dedicated hardware as illustrated in FIG. 10. That is, it is assumed that the Pareto solution search device is implemented by an evaluation value acquiring circuit 11, a distance calculating circuit 12, the rank identifying circuit 15, the Pareto solution candidate selecting circuit 13, and a Pareto solution candidate creating circuit 14.

Each of the evaluation value acquiring circuit 11, the distance calculating circuit 12, the rank identifying circuit 15, the Pareto solution candidate selecting circuit 13, and the Pareto solution candidate creating circuit 14 is a single circuit, a composite circuit, a programmed processor, a parallel-programmed processor, an ASIC, an FPGA, or a combination thereof, for example.

The components of the Pareto solution search device are not necessarily implemented by dedicated hardware, and the Pareto solution search device may be implemented by software, firmware, or a combination of software and firmware.

In a case where the Pareto solution search device is implemented by software, firmware, or the like, a program for causing a computer to execute the respective processing procedures performed in the evaluation value acquiring unit 1, the distance calculating unit 2, the rank identifying unit 5, the Pareto solution candidate selecting unit 3, and the Pareto solution candidate creating unit 4 is stored in a memory 21 shown in FIG. 3. The processor 22 shown in FIG. 3 then executes the program stored in the memory 21.

Further, FIG. 10 illustrates an example in which each of the components of the Pareto solution search device is implemented by dedicated hardware, and FIG. 3 illustrates an example in which the Pareto solution search device is implemented by software, firmware, or the like. However, this is merely an example, and some components in the Pareto solution search device may be implemented by dedicated hardware, while the remaining components may be implemented by software, firmware, or the like.

Next, operations to be performed by the Pareto solution search device illustrated in FIG. 9 are described. Note that, except for the rank identifying unit 5 and the first selection processing unit 3c, the operations are the same as those by the Pareto solution search device illustrated in FIG. 1. Therefore, operations to be performed by the rank identifying unit 5 and the first selection processing unit 3c are mainly described herein.

The rank identifying unit 5 acquires Pareto solution candidates PSₘ (m=1, . . . , M) and evaluation values Evₘ of the Pareto solution candidates PSₘ from the evaluation value acquiring unit 1.

The rank identifying unit 5 determines superiority of the M Pareto solution candidates PS₁ to PS_{M}, on the basis of the evaluation values Evₘ.

In the following, the process to be performed by the rank identifying unit 5 to determine superiority is specifically described.

For ease of explanation, an example in which the rank identifying unit 5 determines superiority between a Pareto solution candidate PSₘ and the Pareto solution candidate PSₘ₊₁ is described herein.

The rank identifying unit 5 compares the evaluation value Evₘ of the Pareto solution candidate PSₘ with the evaluation value Evₘ₊₁ of the Pareto solution candidate PSₘ₊₁.

If the evaluation value Evₘ of the Pareto solution candidate PSₘ is higher than the evaluation value Evₘ₊₁ of the Pareto solution candidate PSₘ₊₁, the rank identifying unit 5 determines that the Pareto solution candidate PSₘ is superior to the Pareto solution candidate PSₘ₊₁.

If the evaluation value Evₘ of the Pareto solution candidate PSₘ is lower than the evaluation value Evₘ₊₁ of the Pareto solution candidate PSₘ₊₁, the rank identifying unit 5 determines that the Pareto solution candidate PSₘ is inferior to the Pareto solution candidate PSₘ₊₁.

The rank identifying unit 5 identifies the rank Rk to which the Pareto solution candidate PSₘ (m=1, . . . , M) belongs, on the basis of the result of the determination of the superiority.

In the following, the process to be performed by the rank identifying unit 5 to calculate the rank Rk is specifically described.

In the example in FIG. 6, it is assumed that, with attention being paid to the Pareto solution candidate PS₁, the Pareto solution candidates having the same evaluation value as the evaluation value Ev₁ of the Pareto solution candidate PS₁ are the two of the Pareto solution candidate PS₂ and the Pareto solution candidate PS₃. Also, it is assumed that the evaluation values Ev₄ to Ev₁₀ of the Pareto solution candidates PS₄ to PS₁₀ are lower than the evaluation value Ev₁ of the Pareto solution candidate PS₁.

In this case, each of the Pareto solution candidate PS₁, the Pareto solution candidate PS₂, and the Pareto solution candidate PS₃ is classified into a rank Rk₁ that is the highest rank as illustrated in FIG. 11.

FIG. 11 is an explanatory diagram illustrating the ranks Rk to which the Pareto solution candidates PSₘ (m=1, . . . , M) belong.

With attention being paid to the Pareto solution candidate PS₄, the Pareto solution candidates having the same evaluation value as the evaluation value Ev₄ of the Pareto solution candidate PS₄ are the four of the Pareto solution candidates PS₅ to PS₈. Also, it is assumed that the evaluation values Ev₉ and Ev₁₀ of the Pareto solution candidates PS₉ and PS₁₀ are lower than the evaluation value Ev₄ of the Pareto solution candidate PS₄.

In this case, each of the Pareto solution candidates PS₄ to PS₈ is classified into a rank Rk₂ that is the second highest rank.

With attention being paid to the Pareto solution candidate PS₉, the Pareto solution candidate having the same evaluation value as the evaluation value Ev₉ of the Pareto solution candidate PS₉ is the Pareto solution candidate PS₁₀. Also, it is assumed that the evaluation values Ev₉ and Ev₁₀ of the Pareto solution candidates PS₉ and PS₁₀ are lower than the evaluation value Ev₄ of the Pareto solution candidate PS₄.

In this case, each of the Pareto solution candidates PS₉ and PS₁₀ is classified into a rank Rk₃ that is the third highest rank.

Here, it is assumed that the evaluation value Ev₁ of the Pareto solution candidate PS₁ is the same evaluation value as the evaluation value Ev₂ of the Pareto solution candidate PS₂. The same evaluation value herein does not necessarily mean an exact match between the evaluation value Ev₁ and the evaluation value Ev₂, but, when the difference between the evaluation value Ev₁ and the evaluation value Ev₂ is equal to or smaller than a certain threshold, these evaluation values may be regarded as the same.

The rank identifying unit 5 outputs the ranks Rk to which the Pareto solution candidates PSₘ (m=1, . . . , M) belong, to the Pareto solution candidate selecting unit 3.

The first selection processing unit 3c of the Pareto solution candidate selecting unit 3 acquires the Pareto solution candidates PSₘ (m=1, . . . , M) from the evaluation value acquiring unit 1, and acquires the relative distances Lₘ (m=1, . . . , M) between the M Pareto solution candidates PS₁ to PS_{M} from the distance calculating unit 2.

Also, the first selection processing unit 3c acquires the ranks Rk to which the Pareto solution candidates PSₘ belong, from the rank identifying unit 5.

When the number of the Pareto solution candidates to be selected by the second selection processing unit 3b is G, the first selection processing unit 3c sets the number N of the Pareto solution candidates to be selected from among the M Pareto solution candidates PS₁ to PS_{M} to a value that is greater than G but is not greater than M.

When preferentially selecting the Pareto solution candidate PSₘ classified into a high rank from among the M Pareto solution candidates PS₁ to PS_{M}, and selecting one or more Pareto solution candidates PSₘ classified into a certain rank, the first selection processing unit 3c selects all the Pareto solution candidates PSₘ classified into the certain rank.

Therefore, in the example in FIG. 11, N is set to three (N=3) when G=1 to 3, N is set to eight (N=8) when G=4 to 8, and N is set to ten (N=10) when G=9 to 10.

The first selection processing unit 3c selects N Pareto solution candidates PS′₁ to PS′_{N} from among the M Pareto solution candidates PS₁ to PS_{M}.

In the example in FIG. 11, when N=3, the first selection processing unit 3c selects the three Pareto solution candidates PS₁ to PS₃ classified into the rank Rk₁.

When N=8, the first selection processing unit 3c selects the three Pareto solution candidates PS₁ to PS₃ classified into the rank Rk₁, and the five Pareto solution candidates PS₄ to PS₈ classified into the rank Rk₂.

For example, when N=10, the first selection processing unit 3c selects the three Pareto solution candidates PS₁ to PS₃ classified into the rank Rk₁, the five Pareto solution candidates PS₄ to PS₈ classified into the rank Rk₂, and the two Pareto solution candidates PS, and PS₁₀ classified into the rank Rk₃.

The second selection processing unit 3b selects G Pareto solution candidates PS″₁ to PS″_{G} from among the N Pareto solution candidates PS′₁ to PS′_{N}, on the basis of the respective evaluation values Ev′ₙ (n=1, . . . , N) of the N Pareto solution candidates PS′₁ to PS′_{N} selected by the first selection processing unit 3c.

In the example in FIG. 11, when G=1, the second selection processing unit 3b selects one Pareto solution candidate of the three Pareto solution candidates PS₁ to PS₃ classified into the rank Rk₁. When there is a slight difference among the evaluation values Ev₁ to Ev₃ of the three Pareto solution candidates PS₁ to PS₃, the one Pareto solution candidate having the highest evaluation value is selected. When all the evaluation values Ev₁ to Ev₃ are the same, one Pareto solution candidate is selected as appropriate.

When G=2, the second selection processing unit 3b selects two Pareto solution candidates of the three Pareto solution candidates PS₁ to PS₃ classified into the rank Rk₁. In this case, when there is a slight difference among the evaluation values Ev₁ to Ev₃, the two Pareto solution candidates having the higher evaluation values are also selected. When all the evaluation values Ev₁ to Ev₃ are the same, any two Pareto solution candidates are selected as appropriate.

When G=3, the second selection processing unit 3b selects all the three Pareto solution candidates PS₁ to PS₃ classified into the rank Rk₁.

When G=4 to 8, the second selection processing unit 3b selects the three Pareto solution candidates PS₁ to PS₃ classified into the rank Rk₁, and one or more but less than six Pareto solution candidates among the five Pareto solution candidates PS₄ to PS₈ classified into the rank Rk₂. In this case, one or more but less than six Pareto solution candidates having relatively high evaluation values are also selected from among the five Pareto solution candidates PS₄ to PS₈, for example.

When G=9 or 10, the second selection processing unit 3b selects the three Pareto solution candidates PS₁ to PS₃ classified into the rank Rk₁, the five Pareto solution candidates PS₄ to PS₈ classified into the rank Rk₂, and one or two Pareto solution candidates of the two Pareto solution candidates PS₉ and PS₁₀ classified into the rank Rk₃. In this case, one or two Pareto solution candidates having relatively high evaluation values are also selected between the two Pareto solution candidates PS₉ and PS₁₀, for example.

The second selection processing unit 3b outputs the selected G Pareto solution candidates PS″₁ to PS″_{G} to the Pareto solution candidate creating unit 4.

In the Pareto solution search device illustrated in FIG. 9, when selecting one or more Pareto solution candidates PSₘ classified into a certain rank, the first selection processing unit 3c selects all the Pareto solution candidates PSₘ classified into the certain rank. Specifically, in the example in FIG. 11, the first selection processing unit 3c sets N to three (N=3) when G=1 to 3, the first selection processing unit 3c sets N to eight (N=8) when G=4 to 8, and the first selection processing unit 3c sets N to then (N=10) when G=9 or 10. Note that Nis only required to be not greater than M but be greater than G, and is not limited to the above settings.

When N=5, for example, the first selection processing unit 3c selects the three Pareto solution candidates PS₁ to PS₃ classified into the rank Rk₁, and two Pareto solution candidates among the five Pareto solution candidates PS₄ to PS₈ classified into the rank Rk₂. In this case, the two Pareto solution candidates having the longer relative distances Lₘ (m=4, . . . , 8) are selected from among the five Pareto solution candidates PS₄ to PS₈.

When N=9, for example, the first selection processing unit 3c selects the three Pareto solution candidates PS₁ to PS₃ classified into the rank Rk₁, the five Pareto solution candidates PS₄ to PS₈ classified into the rank Rk₂, and one Pareto solution candidate of the two Pareto solution candidates PS₉ and PS₁₀ classified into the rank Rk₃. In this case, the Pareto solution candidate having the longer relative distance Lₘ (m=9 or 10) is selected between the two Pareto solution candidates PS₉ and PS₁₀.

In the second embodiment, the Pareto solution search device is configured to include the rank identifying unit 5 that determines superiority of M Pareto solution candidates on the basis of evaluation values acquired by an evaluation value acquiring unit 1, and identifies ranks to which the respective Pareto solution candidates belong among a plurality of ranks, on the basis of the result of the determination of the superiority. Further, the first selection processing unit 3c of the Pareto solution search device selects Pareto solution candidates from among the Pareto solution candidates belonging to the respective ranks on the basis of relative distances so that the number of selected Pareto solution candidates is N in total. Thus, the Pareto solution search device can select more diverse Pareto solution candidates than the device disclosed in Patent Literature 1 can.

### Third Embodiment

A third embodiment concerns a Pareto solution search device including an evaluation value correcting unit 6 that corrects evaluation values of all Pareto solution candidates included in a Pareto frontier so that the evaluation values of all the Pareto solution candidates included in the Pareto frontier among M Pareto solution candidates PS₁ to PS_{M} become 1 or greater.

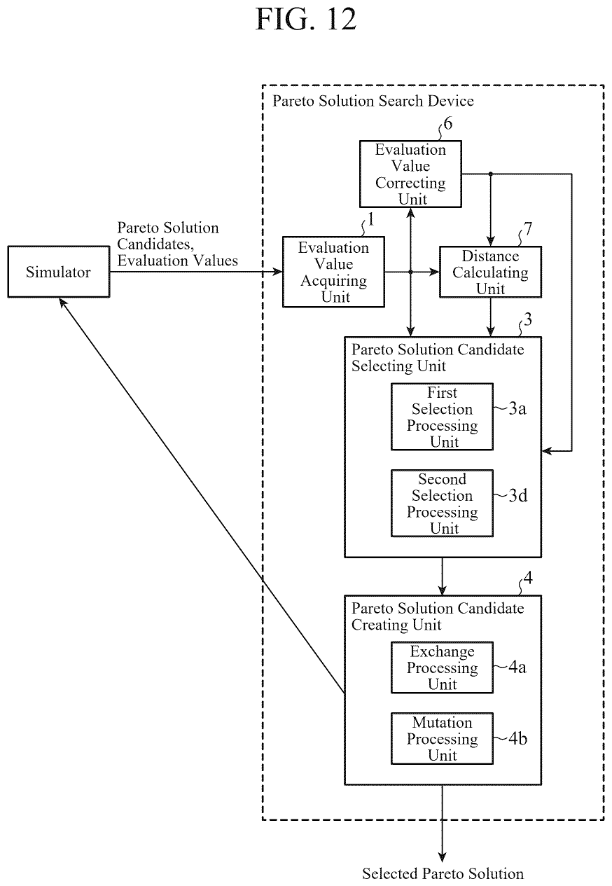

FIG. 12 is a configuration diagram illustrating the Pareto solution search device according to the third embodiment. In FIG. 12, the same reference numerals as those in FIG. 1 denote the same or corresponding components, and therefore, detailed explanation of them is not made herein.

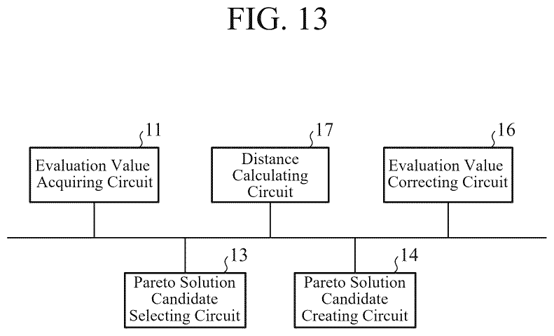

FIG. 13 is a hardware configuration diagram illustrating the hardware of the Pareto solution search device according to the third embodiment. In FIG. 13, the same reference numerals as those in FIG. 2 denote the same or corresponding components, and therefore, detailed explanation of them is not made herein.

The Pareto solution search device illustrated in FIG. 12 is a device for executing a genetic algorithm using DEA, and includes an evaluation value acquiring unit 1, the evaluation value correcting unit 6, a distance calculating unit 7, a Pareto solution candidate selecting unit 3, and a Pareto solution candidate creating unit 4.

The evaluation value correcting unit 6 is implemented by an evaluation value correcting circuit 16 shown in FIG. 13, for example.

The evaluation value correcting unit 6 acquires Pareto solution candidates PSₘ (m=1, . . . , M) and evaluation values Evₘ of the Pareto solution candidates PSₘ from the evaluation value acquiring unit 1.

The evaluation value correcting unit 6 identifies Pareto solution candidates PS_{PFj} (j=1, . . . , J) included in a Pareto frontier PF among the M Pareto solution candidates PS₁ to PS_{M}, on the basis of the evaluation values Evₘ of the Pareto solution candidates PSₘ. J is an integer that is not smaller than 1 but is not greater than M.

The evaluation value correcting unit 6 corrects evaluation values Ev_{PFj} (j=1, . . . , J) of all the Pareto solution candidates PS_{PF1} to PS_{PFJ} included in the Pareto frontier PF so that the evaluation values Ev_{PFj} of all the Pareto solution candidates PS_{PF1} to PS_{PFJ} included in the Pareto frontier PF become 1 or greater.

The evaluation value correcting unit 6 outputs the Pareto solution candidates PS_{PF1} to PS_{PFJ} after the evaluation value correction to each of the distance calculating unit 7 and the Pareto solution candidate selecting unit 3, and outputs the corrected evaluation values Ev_{PFj}′ to the Pareto solution candidate selecting unit 3.

The distance calculating unit 7 is implemented by a distance calculating circuit 17 shown in FIG. 13, for example.

The distance calculating unit 7 acquires the Pareto solution candidates PS_{PF1} to PS_{PFJ} after the evaluation value correction from the evaluation value correcting unit 6.

The distance calculating unit 7 acquires, from the evaluation value acquiring unit 1, the Pareto solution candidates PSₘ not included in the Pareto frontier PF among the M Pareto solution candidates PS₁ to PS_{M}.

The distance calculating unit 7 calculates relative distances Lₘ between the M Pareto solution candidates PS₁ to PS_{M} including the Pareto solution candidates PS_{PF1} to PS_{PFJ} after the evaluation value correction and the Pareto solution candidates PSₘ not included in the Pareto frontier PF.

The distance calculating unit 7 outputs the relative distances Lₘ between the M Pareto solution candidates PS₁ to PS_{M} to the Pareto solution candidate selecting unit 3.

The Pareto solution candidate selecting unit 3 is implemented by a Pareto solution candidate selecting circuit 13 shown in FIG. 13, for example.

The Pareto solution candidate selecting unit 3 includes a first selection processing unit 3a and a second selection processing unit 3d.

The second selection processing unit 3d selects G Pareto solution candidates PS″₁ to PS″_{G} from among the N Pareto solution candidates PS′₁ to PS′_{N}, on the basis of the respective evaluation values Evₙ (n=1, . . . , N) of the N Pareto solution candidates PS′₁ to PS′_{N} selected by the first selection processing unit 3a.

When the Pareto solution candidates PS' selected by the first selection processing unit 3a are the Pareto solution candidates PS_{PFj} included in the Pareto frontier PF, the second selection processing unit 3d uses the evaluation values Ev_{PFj}′ corrected by the evaluation value correcting unit 6 as the evaluation values Evₙ.

When the Pareto solution candidates PS' selected by the first selection processing unit 3a are the Pareto solution candidates PSₘ not included in the Pareto frontier PF, the second selection processing unit 3d uses the evaluation values Evₘ acquired by the evaluation value acquiring unit 1 as the evaluation values Evₙ.

In FIG. 12, it is assumed that each of the evaluation value acquiring unit 1, the evaluation value correcting unit 6, the distance calculating unit 7, the Pareto solution candidate selecting unit 3, and the Pareto solution candidate creating unit 4, which are components of the Pareto solution search device, is implemented by dedicated hardware as illustrated in FIG. 13. That is, it is assumed that the Pareto solution search device is implemented by the evaluation value acquiring circuit 11, the evaluation value correcting circuit 16, the distance calculating circuit 17, the Pareto solution candidate selecting circuit 13, and the Pareto solution candidate creating circuit 14.

Each of the evaluation value acquiring circuit 11, the evaluation value correcting circuit 16, the distance calculating circuit 17, the Pareto solution candidate selecting circuit 13, and the Pareto solution candidate creating circuit 14 is a single circuit, a composite circuit, a programmed processor, a parallel-programmed processor, an ASIC, an FPGA, or a combination thereof, for example.

The components of the Pareto solution search device are not necessarily implemented by dedicated hardware, and the Pareto solution search device may be implemented by software, firmware, or a combination of software and firmware.

In a case where the Pareto solution search device is implemented by software, firmware, or the like, a program for causing a computer to execute the respective processing procedures performed in the evaluation value acquiring unit 1, the evaluation value correcting unit 6, the distance calculating unit 7, the Pareto solution candidate selecting unit 3, and the Pareto solution candidate creating unit 4 is stored in the memory 21 shown in FIG. 3. The processor 22 shown in FIG. 3 then executes the program stored in the memory 21.

Further, FIG. 13 illustrates an example in which each of the components of the Pareto solution search device is implemented by dedicated hardware, and FIG. 3 illustrates an example in which the Pareto solution search device is implemented by software, firmware, or the like. However, this is merely an example, and some components in the Pareto solution search device may be implemented by dedicated hardware, while the remaining components may be implemented by software, firmware, or the like.

Next, operations to be performed by the Pareto solution search device illustrated in FIG. 12 are described. Note that, except for the evaluation value correcting unit 6, the distance calculating unit 7, and the second selection processing unit 3d, the operations are the same as those by the Pareto solution search device illustrated in FIG. 1. Therefore, operations to be performed by the evaluation value correcting unit 6, the distance calculating unit 7, and the second selection processing unit 3d are mainly described herein.

The evaluation value correcting unit 6 acquires Pareto solution candidates PSₘ (m=1, . . . , M) and evaluation values Evₘ of the Pareto solution candidates PSₘ from the evaluation value acquiring unit 1.

The evaluation value correcting unit 6 identifies Pareto solution candidates PS_{PFj} (j=1, . . . , J) included in a Pareto frontier PF among the M Pareto solution candidates PS₁ to PS_{M}, on the basis of the evaluation values Evₘ of the Pareto solution candidates PSₘ.

Assuming that the Pareto solution candidates PS_{PFj} included in the Pareto frontier PF are the Pareto solution candidates PSₘ belonging to a rank Rk₁, for example, the evaluation value correcting unit 6 may identify the Pareto solution candidates PSₘ belonging to the rank Rk₁, like the rank identifying unit 5 shown in FIG. 9.

The evaluation value correcting unit 6 corrects evaluation values Ev_{PFj} (j=1, . . . , J) of all the Pareto solution candidates PS_{PF1} to PS_{PFJ} included in the Pareto frontier PF so that the evaluation values Ev_{PFj} of all the Pareto solution candidates PS_{PF1} to PS_{PFJ} included in the Pareto frontier PF become 1 or greater.

On the assumption that the Pareto solution candidates included in the Pareto frontier PF are PS₁ to PS₃, the evaluation values Ev₁ of PS₁ are “1.1”, the evaluation value Ev₂ of PS₂ is “1.05”, and the evaluation value Ev₃ of PS₃ is “0.95”, for example, the correction process to be performed by the evaluation value correcting unit 6 is specifically described below.

The evaluation value correcting unit 6 calculates a coefficient α with which the evaluation value Ev₃ of the Pareto solution candidate PS₃ having the smallest evaluation value among the Pareto solution candidates PS₁ to PS₃ becomes “1.0”, as expressed in the following Formula (8).

$$α = \frac{1.}{{Ev}_{3}} = \frac{1.0}{0.95} = 1 \text{.053} \qquad ( 8 )$$

The evaluation value correcting unit 6 corrects the respective evaluation values Ev₁ to Ev₃ of the Pareto solution candidates PS₁ to PS₃ by multiplying the respective Pareto solution candidates PS₁ to PS₃ by the coefficient α, as expressed in the following Formula (9).

$${Ev}_{PF 1}^{′} = {Ev}_{1} \times α = 1.1 \times 1.053 = 1 \text{.158} \qquad ( 9 )$$

$${Ev}_{PF 2}^{′} = {Ev}_{2} \times α = 1.05 \times 1.053 = 1 \text{.106}$$

$${Ev}_{PF 3}^{′} = {Ev}_{3} \times α = 0.95 \times 1.053 = 1.$$

In Formula (9), each of Ev₁′, Ev₂′, and Ev₃′ is a corrected evaluation value.

The evaluation value correcting unit 6 outputs the corrected evaluation values Ev_{PF1}′, Ev_{PF2}′, and Ev_{PF3}′ to each of the distance calculating unit 7 and the second selection processing unit 3d.

The distance calculating unit 7 acquires the Pareto solution candidates PS_{PF1} to PS_{PFJ} after the evaluation value correction from the evaluation value correcting unit 6.

The distance calculating unit 7 acquires, from the evaluation value acquiring unit 1, the Pareto solution candidates PSₘ not included in the Pareto frontier PF among the M Pareto solution candidates PS₁ to PS_{M}.

The distance calculating unit 7 calculates relative distances Lₘ between the M Pareto solution candidates PS₁ to PS_{M} including the Pareto solution candidates PS_{PF1} to PS_{PFJ} after the evaluation value correction and the Pareto solution candidates PSₘ not included in the Pareto frontier PF. The process of calculating the relative distances Lₘ between the M Pareto solution candidates PS₁ to PS_{M} is the same as that performed by the distance calculating unit 2 shown in FIG. 1.

The distance calculating unit 7 outputs the relative distances Lₘ between the M Pareto solution candidates PS₁ to PS_{M} to the Pareto solution candidate selecting unit 3.

As described in the first embodiment, the first selection processing unit 3a selects N Pareto solution candidates PS′₁ to PS′_{N} from among the M Pareto solution candidates PS₁ to PS_{M}, and outputs the N Pareto solution candidates PS′₁ to PS′_{N} to the second selection processing unit 3d.

The second selection processing unit 3d acquires the N Pareto solution candidates PS′₁ to PS′_{N} from the first selection processing unit 3a.

The second selection processing unit 3d acquires the corrected evaluation values Ev_{PFj}′ (j=1, . . . , J) from the evaluation value correcting unit 6, and acquires the evaluation values Evₘ of the Pareto solution candidates PSₘ not included in the Pareto frontier PF from the evaluation value acquiring unit 1.

The second selection processing unit 3d selects G Pareto solution candidates PS″₁ to PS″_{G} from among the N Pareto solution candidates PS′₁ to PS′_{N}, on the basis of the respective evaluation values Evₙ (n=1, . . . , N) of the N Pareto solution candidates PS′₁ to PS′_{N}.

When the Pareto solution candidates PS' selected by the first selection processing unit 3a are the Pareto solution candidates PS_{PFj} included in the Pareto frontier PF, the second selection processing unit 3d uses the evaluation values Ev_{PFj}′ corrected by the evaluation value correcting unit 6 as the evaluation values Evₙ.

When the Pareto solution candidates PS' selected by the first selection processing unit 3a are the Pareto solution candidates PSₘ not included in the Pareto frontier PF, the second selection processing unit 3d uses the evaluation values Evₘ acquired by the evaluation value acquiring unit 1 as the evaluation values Evₙ.

In the third embodiment, the Pareto solution search device illustrated in FIG. 12 is configured to include the evaluation value correcting unit 6 that identifies all the Pareto solution candidates included in a Pareto frontier among M Pareto solution candidates on the basis of evaluation values acquired by the evaluation value acquiring unit 1, and corrects the evaluation values of all the Pareto solution candidates included in the Pareto frontier so that the evaluation values of all the Pareto solution candidates included in the Pareto frontier become 1 or greater. Further, the Pareto solution candidate selecting unit 3 of the Pareto solution search device illustrated in FIG. 12 selects G Pareto solution candidates from among the M Pareto solution candidates, on the basis of the relative distances calculated by the distance calculating unit 7, the evaluation values corrected by the evaluation value correcting unit 6, and the evaluation values of the Pareto solution candidates not included in the Pareto frontier among the M Pareto solution candidates. Thus, like the Pareto solution search device illustrated in FIG. 1, the Pareto solution search device illustrated in FIG. 12 can select more diverse Pareto solution candidates than the device disclosed in Patent Literature 1 can. Furthermore, the Pareto solution search device illustrated in FIG. 12 can increase the probability that Pareto solution candidates included in the Pareto frontier are selected.

### Fourth Embodiment

A fourth embodiment concerns a Pareto solution search device including a shape correcting unit 8 that corrects the shape of a Pareto frontier by correcting Pareto solution candidates included in the Pareto frontier among M Pareto solution candidates PS₁ to PS_{M}.

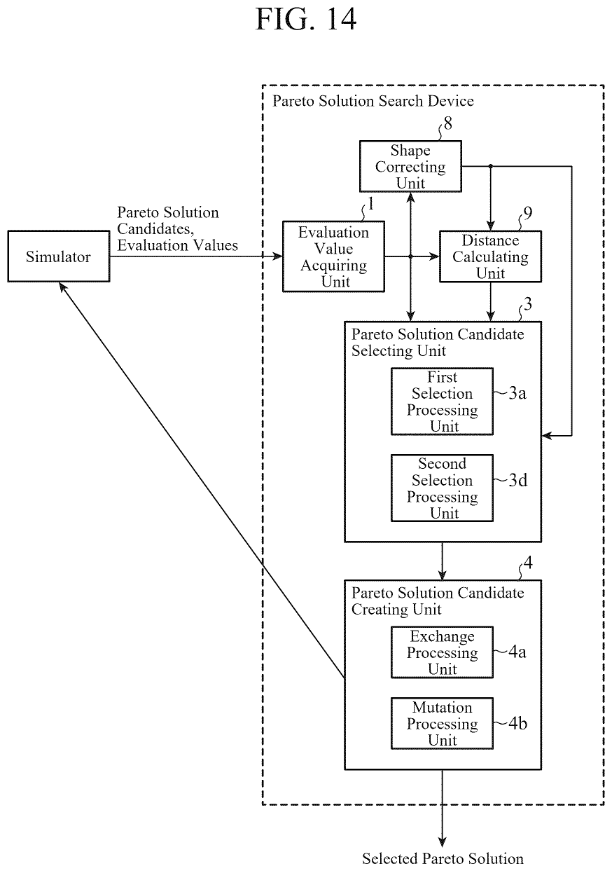

FIG. 14 is a configuration diagram illustrating the Pareto solution search device according to the fourth embodiment. In FIG. 14, the same reference numerals as those in FIG. 1 denote the same or corresponding components, and therefore, detailed explanation of them is not made herein.

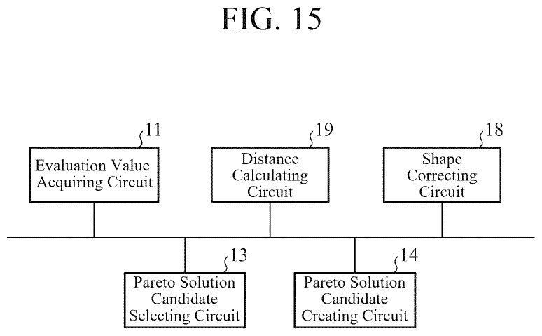

FIG. 15 is a hardware configuration diagram illustrating the hardware of the Pareto solution search device according to the fourth embodiment. In FIG. 15, the same reference numerals as those in FIG. 2 denote the same or corresponding components, and therefore, detailed explanation of them is not made herein.

The Pareto solution search device illustrated in FIG. 14 is a device for executing a genetic algorithm using DEA, and includes an evaluation value acquiring unit 1, the shape correcting unit 8, a distance calculating unit 9, a Pareto solution candidate selecting unit 3, and a Pareto solution candidate creating unit 4.

The shape correcting unit 8 is implemented by a shape correcting circuit 18 shown in FIG. 15, for example.

The shape correcting unit 8 acquires Pareto solution candidates PSₘ (m=1, . . . , M) and evaluation values Evₘ of the Pareto solution candidates PSₘ from the evaluation value acquiring unit 1.

The shape correcting unit 8 identifies Pareto solution candidates PS_{PFj} (j=1, . . . , J) included in a Pareto frontier PF among the M Pareto solution candidates PS₁ to PS_{M}, on the basis of the evaluation values Evₘ of the Pareto solution candidates PSₘ. J is an integer that is not smaller than 1 but is not greater than M.

The shape correcting unit 8 corrects the shape of the Pareto frontier PF by correcting Pareto solution candidates PS_{PFj} included in the Pareto frontier PF.

The shape correcting unit 8 outputs the corrected Pareto solution candidates PS_{PFj}′ to each of the distance calculating unit 9 and the Pareto solution candidate selecting unit 3.

The distance calculating unit 9 is implemented by a distance calculating circuit 19 shown in FIG. 15, for example.

The distance calculating unit 9 acquires the Pareto solution candidates PS_{PFj}′ corrected by the shape correcting unit 8, and the Pareto solution candidates PSₘ not corrected by the shape correcting unit 8 among the evaluation values of the M Pareto solution candidates PS₁ to PS_{M}.

The distance calculating unit 9 calculates relative distances Lₘ between the M Pareto solution candidates PS₁ to PS_{M} including the corrected Pareto solution candidates PS_{PFj}′ and the Pareto solution candidates PSₘ not corrected by the shape correcting unit 8 among the M Pareto solution candidates PS₁ to PS_{M}.

The distance calculating unit 9 outputs the relative distances Lₘ between the M Pareto solution candidates PS₁ to PS_{M} to the Pareto solution candidate selecting unit 3.

The Pareto solution candidate selecting unit 3 is implemented by a Pareto solution candidate selecting circuit 13 shown in FIG. 15, for example.

The Pareto solution candidate selecting unit 3 includes a first selection processing unit 3a and a second selection processing unit 3e.

The second selection processing unit 3e selects G Pareto solution candidates PS″₁ to PS″_{G} from among N Pareto solution candidates PS′₁ to PS′_{N}, on the basis of the respective evaluation values Evₙ (n=1, . . . , N) of the N Pareto solution candidates PS′₁ to PS′_{N} selected by the first selection processing unit 3a.

When the Pareto solution candidates PS' selected by the first selection processing unit 3a are the Pareto solution candidates PS_{PFj}′ corrected by the shape correcting unit 8, the second selection processing unit 3d uses the evaluation values Ev_{PFj} of the Pareto solution candidates PS_{PFj}′ corrected by the shape correcting unit 8.

When the Pareto solution candidates PS' selected by the first selection processing unit 3a are the Pareto solution candidates having evaluation values not corrected by the shape correcting unit 8, the second selection processing unit 3d uses the evaluation values Evₙ of the Pareto solution candidates PSₙ having evaluation values not corrected by the shape correcting unit 8.

In FIG. 14, it is assumed that each of the evaluation value acquiring unit 1, the shape correcting unit 8, the distance calculating unit 9, the Pareto solution candidate selecting unit 3, and the Pareto solution candidate creating unit 4, which are components of the Pareto solution search device, is implemented by dedicated hardware as illustrated in FIG. 15. That is, it is assumed that the Pareto solution search device is implemented by the evaluation value acquiring circuit 11, the shape correcting circuit 18, the distance calculating circuit 19, the Pareto solution candidate selecting circuit 13, and the Pareto solution candidate creating circuit 14.

Each of the evaluation value acquiring circuit 11, the shape correcting circuit 18, the distance calculating circuit 19, the Pareto solution candidate selecting circuit 13, and the Pareto solution candidate creating circuit 14 is a single circuit, a composite circuit, a programmed processor, a parallel-programmed processor, an ASIC, an FPGA, or a combination thereof, for example.

The components of the Pareto solution search device are not necessarily implemented by dedicated hardware, and the Pareto solution search device may be implemented by software, firmware, or a combination of software and firmware.

In a case where the Pareto solution search device is implemented by software, firmware, or the like, a program for causing a computer to execute the respective processing procedures performed in the evaluation value acquiring unit 1, the shape correcting unit 8, the distance calculating unit 9, the Pareto solution candidate selecting unit 3, and the Pareto solution candidate creating unit 4 is stored in the memory 21 shown in FIG. 3. The processor 22 shown in FIG. 3 then executes the program stored in the memory 21.

Further, FIG. 15 illustrates an example in which each of the components of the Pareto solution search device is implemented by dedicated hardware, and FIG. 3 illustrates an example in which the Pareto solution search device is implemented by software, firmware, or the like. However, this is merely an example, and some components in the Pareto solution search device may be implemented by dedicated hardware, while the remaining components may be implemented by software, firmware, or the like.

Next, operations to be performed by the Pareto solution search device illustrated in FIG. 14 are described. Note that, except for the shape correcting unit 8, the distance calculating unit 9, and the second selection processing unit 3e, the operations are the same as those by the Pareto solution search device illustrated in FIG. 1. Therefore, operations to be performed by the shape correcting unit 8, the distance calculating unit 9, and the second selection processing unit 3e are mainly described herein.

The shape correcting unit 8 acquires Pareto solution candidates PSₘ (m=1, . . . , M) and evaluation values Evₘ of the Pareto solution candidates PSₘ from the evaluation value acquiring unit 1.

The shape correcting unit 8 identifies Pareto solution candidates PS_{PFj} (j=1, . . . , J) included in a Pareto frontier PF among the M Pareto solution candidates PS₁ to PS_{M}, on the basis of the evaluation values Evₘ of the Pareto solution candidates PSₘ.

Assuming that the Pareto solution candidates PS_{PFj} included in the Pareto frontier PF are the Pareto solution candidates PSₘ belonging to a rank Rk₁, for example, the shape correcting unit 8 may identify the Pareto solution candidates PSₘ belonging to the rank Rk₁, like the rank identifying unit 5 shown in FIG. 9.

In the example in FIG. 11, the Pareto solution candidates PSₘ belonging to the rank Rk₁ are PS₁ to PS₃, and the shape of the Pareto frontier PF including PS₁ to PS₃ is a so-called convex shape.

A convex shape is a shape in which the Pareto solution candidates PSₘ asymptotically approach the x-axis related to the objective function f₁ as the value f₁(x, y) of the objective function f₁ increases, and the Pareto solution candidates PSₘ asymptotically approach the y-axis related to the objective function f₂ as the value f₂(x, y) of the objective function f₂ increases.

When the shape of the Pareto frontier PF is a convex shape, there is a high possibility that the Pareto solution candidates PS_{PFj} included in the Pareto frontier PF are optimal solutions.

Also, when the shape of the Pareto frontier PF is a linear shape, there is a high possibility that the Pareto solution candidates PS_{PFj} included in the Pareto frontier PF are optimal solutions.

On the other hand, when the shape of the Pareto frontier PF is a non-convex shape, there is a low possibility that the Pareto solution candidates PS_{PFj} included in the Pareto frontier PF are optimal solutions. A non-convex shape is neither a convex shape nor a linear shape.

Accordingly, in a case where the shape of the Pareto frontier PF is a non-convex shape, if the shape of the Pareto frontier PF is corrected to have a linear shape, there is a high possibility that the Pareto solution candidates PS_{PFj} included in the Pareto frontier PF turn into optimal solutions.

The shape correcting unit 8 corrects the shape of the Pareto frontier PF by correcting Pareto solution candidates PS_{PFj} included in the Pareto frontier PF.

In the following, a shape correcting process to be performed by the shape correcting unit 8 is specifically described.

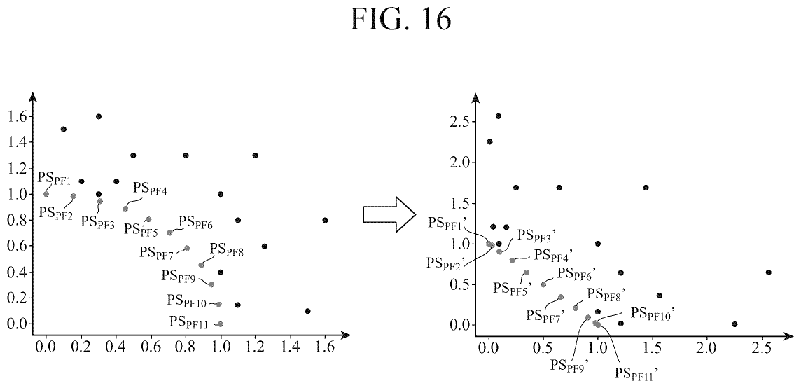

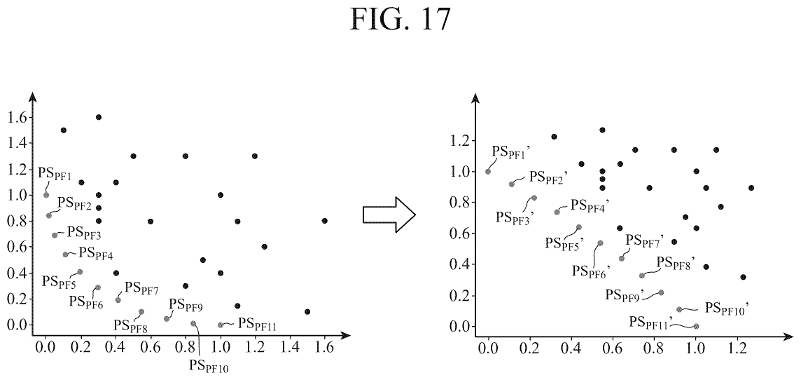

An example in which the shape of the Pareto frontier PF is two-dimensional is described herein. For ease of explanation, it is assumed that the Pareto solution candidates PS_{PFj} included in the Pareto frontier PF are PS_{PF1} to PS_{PF11} as illustrated in FIGS. 16 and 17.

FIG. 16 is an explanatory diagram illustrating an example of the shape correction in a case where the shape of the Pareto frontier PF is a non-convex shape.

FIG. 17 is an explanatory diagram illustrating an example of the shape correction in a case where the shape of the Pareto frontier PF is a convex shape.

The shape correcting unit 8 identifies a parameter p that satisfies Formula (10) shown below. The process of identifying the parameter p is a known technique, and therefore, detailed explanation thereof is not made herein.

The shape correcting unit 8 linearly approximates the shape of the Pareto frontier PF by raising each of the Pareto solution candidates PS_{PF1} to PS_{PF11} to the power of p as expressed in Formula (11) shown below. PS_{PFj}′ represents the corrected Pareto solution candidates.

$${( {PS}_{PF 1}^{p} + {PS}_{PF 2}^{p} + … + {PS}_{PF 11}^{p} )}^{\frac{1}{p}} = 1 \qquad ( 10 )$$

$${PS}_{PFj}^{′} = {PS}_{PFj}^{p} \qquad ( 11 )$$

In the example in FIG. 16, the shape of the Pareto frontier PF is corrected from a non-convex shape to a linear shape.

In the example in FIG. 17, the shape of the Pareto frontier PF is corrected from a convex shape to a linear shape.

These examples illustrate a method by which the shape correcting unit 8 linearly approximates the shape of the Pareto frontier PF by identifying the parameter p satisfying Formula (10) and raising each of the Pareto solution candidates PS_{PF1} to PS_{PF11} to the power of p. However, it is only required to linearly approximate the shape of the Pareto frontier PF, and it goes without saying that the shape correcting unit 8 may use a method other than the above to linearly approximate the shape of the Pareto frontier PF.

FIGS. 16 and 17 illustrate examples in which the shape of the Pareto frontier PF is two-dimensional. Therefore, the shape correcting unit 8 corrects the shape of the Pareto frontier PF so that the shape of the Pareto frontier PF turns into a linear shape. When the shape of the Pareto frontier PF is three-dimensional, the shape correcting unit 8 corrects the shape of the Pareto frontier PF so that the shape of the Pareto frontier PF turns into a plane. When the shape of the Pareto frontier PF is in four or more dimensions, the shape correcting unit 8 corrects the shape of the Pareto frontier PF so that the shape of the Pareto frontier PF turns into a hyperplane.

The distance calculating unit 9 acquires the Pareto solution candidates PS_{PFj}′ corrected by the shape correcting unit 8, and the Pareto solution candidates PSₘ not corrected by the shape correcting unit 8 among the M Pareto solution candidates PS₁ to PS_{M}.

The distance calculating unit 9 calculates relative distances Lₘ between the M Pareto solution candidates PS₁ to PS_{M} including the corrected Pareto solution candidates PS_{PFj}′ and the Pareto solution candidates PSₘ not corrected by the shape correcting unit 8. The process of calculating the relative distances Lₘ between the M Pareto solution candidates PS₁ to PS_{M} is the same as that performed by the distance calculating unit 2 shown in FIG. 1.

The distance calculating unit 9 outputs the relative distances Lₘ between the M Pareto solution candidates PS₁ to PS_{M} to the Pareto solution candidate selecting unit 3.

As described in the first embodiment, the first selection processing unit 3a selects N Pareto solution candidates PS′₁ to PS′_{N} from among the M Pareto solution candidates PS₁ to PS_{M}, and outputs the N Pareto solution candidates PS′₁ to PS′_{N} to the second selection processing unit 3e.

The second selection processing unit 3e acquires the N Pareto solution candidates PS′₁ to PS′_{N} from the first selection processing unit 3a.

The second selection processing unit 3e acquires the evaluation values by the DEA Ev_{PFj} (j=1, . . . , J) of the corrected Pareto solution candidates PS_{PFj}′ from the shape correcting unit 8, and acquires the evaluation values by the DEA Evₘ of the Pareto solution candidates PSₘ from the evaluation value acquiring unit 1.

The second selection processing unit 3e selects G Pareto solution candidates PS″₁ to PS″_{G} from among the N Pareto solution candidates PS′₁ to PS′_{N}, on the basis of the respective evaluation values Evₙ (n=1, . . . , N) of the N Pareto solution candidates PS′₁ to PS′_{N}.

When the Pareto solution candidates PS' selected by the first selection processing unit 3a are the Pareto solution candidates PS_{PFj}′ corrected by the shape correcting unit 8, the second selection processing unit 3e uses the evaluation values Ev_{PFj} of the Pareto solution candidates PS_{PFj}′ corrected by the shape correcting unit 8.

When the Pareto solution candidates PS' selected by the first selection processing unit 3a are the Pareto solution candidates having evaluation values not corrected by the shape correcting unit 8, the second selection processing unit 3e uses the evaluation values Evₙ of the Pareto solution candidates PSₙ not corrected by the shape correcting unit 8.

In the fourth embodiment, the Pareto solution search device illustrated in FIG. 14 is configured to include the shape correcting unit 8 that identifies the Pareto solution candidates included in a Pareto frontier among M Pareto solution candidates on the basis of evaluation values acquired by the evaluation value acquiring unit 1, and corrects the shape of the Pareto frontier by correcting the Pareto solution candidates included in the Pareto frontier. Further, the distance calculating unit 9 of the Pareto solution search device illustrated in FIG. 14 calculates relative distances between the M Pareto solution candidates including the Pareto solution candidates corrected by the shape correcting unit 8 and the Pareto solution candidates not corrected by the shape correcting unit 8 among the M Pareto solution candidates. Thus, like the Pareto solution search device illustrated in FIG. 1, the Pareto solution search device illustrated in FIG. 14 can select more diverse Pareto solution candidates than the device disclosed in Patent Literature 1 can. Furthermore, the Pareto solution search device illustrated in FIG. 14 can increase the probability of selection of Pareto solution candidates that are optimal solutions.

Note that, in the present disclosure, it is possible to freely combine the respective embodiments, modify any of the components of each of the embodiments, or omit any of the components in each of the embodiments.

### INDUSTRIAL APPLICABILITY

The present disclosure is suitable for a Pareto solution search device and a Pareto solution search method.

### REFERENCE SIGNS LIST

1: evaluation value acquiring unit, 2: distance calculating unit, 3: Pareto solution candidate selecting unit, 3a: first selection processing unit, 3b: second selection processing unit, 3c: first selection processing unit, 3d: second selection processing unit, 3e: second selection processing unit, 4: Pareto solution candidate creating unit, 4a: exchange processing unit, 4b: mutation processing unit, 5: rank identifying unit, 6: evaluation value correcting unit, 7: distance calculating unit, 8: shape correcting unit, 9: distance calculating unit, 11: evaluation value acquiring circuit, 12: distance calculating circuit, 13: Pareto solution candidate selecting circuit, 14: Pareto solution candidate creating circuit, 15: rank identifying circuit, 16: evaluation value correcting circuit, 17: distance calculating circuit, 18: shape correcting circuit, 19: distance calculating circuit, 21: memory, 22: processor

1. A Pareto solution search device comprising processing circuitry
to perform acquisition of an evaluation value of each of Pareto solution candidates based on a data envelopment analysis from a simulator that calculates the evaluation value of each of M (M being an integer equal to or greater than 2) Pareto solution candidates based on the data envelopment analysis in a plurality of objective functions corresponding to a multi-objective problem for which a solution is obtained by a genetic algorithm using the data envelopment analysis,
to perform calculation of a relative distance between the M Pareto solution candidates,
to perform selection of G (G being an integer that is equal to or greater than 1 and is smaller than M) Pareto solution candidates from among the M Pareto solution candidates, on a basis of the relative distance and the evaluation value, and
to perform creation of new (M-G) Pareto solution candidates different from the G Pareto solution candidates, using one or more Pareto solution candidates among the G Pareto solution candidates, wherein the processing circuitry is configured, in the selection,
to select N (N being an integer that is equal to or greater than 1 and is not greater than M) Pareto solution candidates from among the M Pareto solution candidates, on a basis of the relative distance, and
to select G (G being an integer that is equal to or greater than 1 and is smaller than N) Pareto solution candidates from among the N Pareto solution candidates, on a basis of the evaluation value of each of the N Pareto solution candidates.

2. The Pareto solution search device according to claim 1, wherein the processing circuitry is further configured
to identify a rank to which each of the Pareto solution candidates belongs among a plurality of ranks on a basis of a result of determination of superiority of the M Pareto solution candidates, by performing the determination on a basis of the evaluation value, and wherein
the processing circuitry performs selection process of the N Pareto solution candidates from among Pareto solution candidates belonging to the ranks on a basis of the relative distance so that a total number of the Pareto solution candidates selected by the selection process is N.

3. A Pareto solution search device comprising processing circuitry
to perform acquisition of an evaluation value of each of Pareto solution candidates based on a data envelopment analysis from a simulator that calculates the evaluation value of each of M (M being an integer equal to or greater than 2) Pareto solution candidates based on the data envelopment analysis in a plurality of objective functions corresponding to a multi-objective problem for which a solution is obtained by a genetic algorithm using the data envelopment analysis,
to perform calculation of a relative distance between the M Pareto solution candidates,
to perform selection of G (G being an integer that is equal to or greater than 1 and is smaller than M) Pareto solution candidates from among the M Pareto solution candidates, on a basis of the relative distance and the evaluation value,
to perform creation of new (M-G) Pareto solution candidates different from the G Pareto solution candidates, using one or more Pareto solution candidates among the G Pareto solution candidates, and
to perform correction of the evaluation values of each of all Pareto solution candidates included in a Pareto frontier so that the evaluation value of each of all the Pareto solution candidates included in the Pareto frontier become 1 or greater, by identifying all the Pareto solution candidates included in the Pareto frontier among the M Pareto solution candidates on a basis of the evaluation value, wherein
the processing circuitry selects, in the selection, the G Pareto solution candidates from among the M Pareto solution candidates, on a basis of the relative distance, the evaluation value after the correction, and the evaluation value of each of Pareto solution candidates not included in the Pareto frontier among the M Pareto solution candidates.

4. A Pareto solution search device comprising processing circuitry
to perform acquisition of an evaluation value of each of Pareto solution candidates based on a data envelopment analysis from a simulator that calculates the evaluation value of each of M (M being an integer equal to or greater than 2) Pareto solution candidates based on the data envelopment analysis in a plurality of objective functions corresponding to a multi-objective problem for which a solution is obtained by a genetic algorithm using the data envelopment analysis,
to perform calculation of a relative distance between the M Pareto solution candidates,
to perform selection of G (G being an integer that is equal to or greater than 1 and is smaller than M) Pareto solution candidates from among the M Pareto solution candidates, on a basis of the relative distance and the evaluation value,
to perform creation of new (M-G) Pareto solution candidates different from the G Pareto solution candidates, using one or more Pareto solution candidates among the G Pareto solution candidates, and
to correct a shape of a Pareto frontier by identifying Pareto solution candidates included in the Pareto frontier among the M Pareto solution candidates on a basis of the evaluation value, and performing correction of a Pareto solution candidate included in the Pareto frontier, wherein
the processing circuitry calculates, in the calculation, a relative distance between the M Pareto solution candidates including the Pareto solution candidate after the correction and Pareto solution candidates not corrected by the correction among the M Pareto solution candidates.

5. The Pareto solution search device according to claim 1, wherein the G Pareto solution candidates and the (M-G) Pareto solution candidates are given to the simulator, and
the acquisition, the calculation, the selection, and the creation are repeated.

6. The Pareto solution search device according to claim 2, wherein the G Pareto solution candidates and the (M-G) Pareto solution candidates are given to the simulator, and
the acquisition, the calculation, the selection, and the creation are repeated.

7. The Pareto solution search device according to claim 3, wherein the G Pareto solution candidates and the (M-G) Pareto solution candidates are given to the simulator, and
the acquisition, the calculation, the selection, and the creation are repeated.

8. The Pareto solution search device according to claim 4, wherein the G Pareto solution candidates and the (M-G) Pareto solution candidates are given to the simulator, and
the acquisition, the calculation, the selection, and the creation are repeated.

9. The Pareto solution search device according to claim 1, wherein the processing circuitry is configured, in the creation,
to acquire two Pareto solution candidates from among the G Pareto solution candidates, and replace a value in one Pareto solution candidate of the two Pareto solution candidates and a value in another one of the two Pareto solution candidates with each other; and
to acquire a Pareto solution candidate from among the G Pareto solution candidates, and change a value in the acquired Pareto solution candidate.

10. The Pareto solution search device according to claim 2, wherein the processing circuitry is configured, in the creation,
to acquire two Pareto solution candidates from among the G Pareto solution candidates, and replace a value in one Pareto solution candidate of the two Pareto solution candidates and a value in another one of the two Pareto solution candidates with each other; and
to acquire a Pareto solution candidate from among the G Pareto solution candidates, and change a value in the acquired Pareto solution candidate.

11. The Pareto solution search device according to claim 3, wherein the processing circuitry is configured, in the creation,
to acquire two Pareto solution candidates from among the G Pareto solution candidates, and replace a value in one Pareto solution candidate of the two Pareto solution candidates and a value in another one of the two Pareto solution candidates with each other; and
to acquire a Pareto solution candidate from among the G Pareto solution candidates, and change a value in the acquired Pareto solution candidate.

12. The Pareto solution search device according to claim 4, wherein the processing circuitry is configured, in the creation,
to acquire two Pareto solution candidates from among the G Pareto solution candidates, and replace a value in one Pareto solution candidate of the two Pareto solution candidates and a value in another one of the two Pareto solution candidates with each other; and
to acquire a Pareto solution candidate from among the G Pareto solution candidates, and change a value in the acquired Pareto solution candidate.
